(19) United States
(12) Patent Application Publication
(10) Pub. No.: US 2008/0018804 A1
(43) Pub. Date: Jan. 24, 2008

(54) TELEVISION RECEIVING APPARATUS EQUIPPED WITH A PLURALITY OF DIGITAL DEMODULATING CIRCUITS

(76) Inventor: Shigeyuki KURAMOTO, Osaka (JP)

Correspondence Address: BIRCH STEWART KOLASCH & BIRCH, PO BOX 747, FALLS CHURCH, VA, 22040-0747, US

(21) Appl. No.: 11/776,103

(22) Filed: Jul. 11, 2007

(30) Foreign Application Priority Data
Jul. 20, 2006 (JP) 2006-197806(P)

(51) Int. Cl. H04N 5/50; H04N 5/455

(52) U.S. Cl. 348/731; 348/726; 348/E05.113; 348/E05.097

(57) ABSTRACT

A television receiving apparatus includes a first tuner unit that receives a broadcast signal and performs frequency conversion on the received broadcast signal into an IF signal or a base band signal for output; a first digital demodulating circuit that demodulates the signal received from the first tuner unit and outputs a digital signal; a casing; a first input terminal; and a second digital demodulating circuit that demodulates a signal received at the first input terminal and outputs a digital signal, wherein the first tuner unit, the first digital demodulating circuit, and the second digital demodulating circuit are housed in the casing, and the first input terminal is attached to the casing.

This nonprovisional application is based on Japanese Patent Application No. 2006-197806 filed with the Japan Patent Office on Jul. 20, 2006, the entire contents of which are hereby incorporated by reference.

### BACKGROUND OF THE INVENTION

1. Field of the Invention

The present invention relates to a television receiving apparatus, and more particularly to a television receiving apparatus including a digital demodulator incorporating front end capable of receiving terrestrial digital broadcasts as well as BS (Broadcasting Satellite) digital broadcasts and CS (Communication Satellite) digital broadcasts.

2. Description of the Background Art

An apparatus for receiving a terrestrial digital broadcast includes a front end unit and a back end unit. The front end unit includes a terrestrial digital tuner unit that receives a terrestrial digital broadcast signal and performs frequency conversion on the received terrestrial digital broadcast signal into an IF signal and a digital demodulating unit that performs OFDM (Orthogonal Frequency Division Multiplex) demodulation and QAM (Quadrature Amplitude Modulation) demodulation on the IF signal to convert the IF signal into a TS (Transport Stream) signal which is a digital signal. The back end unit decodes the TS signal and outputs a video signal, an audio signal, and data.

An apparatus for receiving a satellite digital broadcast includes a front end unit and a back end unit. The front end unit includes a satellite digital tuner unit that receives a satellite digital broadcast signal, namely a BS digital broadcast signal and a CS digital broadcast signal, and performs frequency conversion on the received satellite digital broadcast signal into a base band signal and a digital demodulating unit that performs PSK (Phase Shift Keying) demodulation on the base band signal to convert the base band signal into a TS signal. The back end unit decodes the TS signal and outputs a video signal, an audio signal, and data.

For example, Japanese Patent Laying-Open No. 2002-135668 and Japanese Patent Laying-Open No. 2002-247461 disclose such an apparatus that receives a terrestrial digital broadcast signal and a satellite digital broadcast signal.

Currently, by the appearance of a composite type digital demodulating IC (Integrated Circuit) in which a digital demodulating unit that performs OFDM demodulation and a digital demodulating unit that performs PSK demodulation are integrated on one and the same wafer, a terrestrial/satellite digital composite type tuner has been developed in which a terrestrial digital tuner unit and a satellite digital tuner unit are housed in one and the same casing. Further, a terrestrial/satellite digital demodulation integrated type composite front end (hereinafter also referred to as a composite front end unit) has been developed in which a terrestrial digital tuner unit, a satellite digital tuner unit, and a composite type digital demodulating IC are housed in one and the same casing.

By the presence of this composite front end unit, the front end unit which has conventionally been constructed with a casing of a tuner for receiving a terrestrial digital broadcast and a casing of a tuner for receiving a satellite digital broadcast is housed in one casing. Such a construction saves space and contributes to downsizing and simplification of a television receiving apparatus.

Meanwhile, in the composite front end unit, the terrestrial digital tuner unit and the satellite digital tuner unit are more dominant with respect to the size of the front end unit than that of the composite type digital demodulating IC. In the composite front end unit, the terrestrial digital tuner unit and the satellite digital tuner unit are housed in one casing. Therefore, when the casing is placed vertically with respect to the substrate in the television receiving apparatus, the size of the television receiving apparatus in the height direction will be large. When the casing is placed horizontally with respect to the substrate in the television receiving apparatus, the occupied area relative to the substrate will be large. Therefore, in a television receiving apparatus equipped with a composite front end unit, there has been a problem that it is difficult to reduce the size of the television receiving apparatus as a whole although the downsizing of the digital demodulating unit has been achieved.

Also, in a video image recording apparatus, one must design a front end unit having a function of dividing a digital broadcast signal into two and outputting one of the divided signals through to the outside. In this case, one can consider a construction in which RF output terminals for through-output of a terrestrial digital broadcast signal and a satellite digital broadcast signal are respectively provided in the front end unit. However, with such a construction, the sum of four RF terminals, namely two RF input terminals and two RF output terminals, for digital broadcast signals will be needed, so that the size of the front end unit in the vertical direction or in the horizontal direction will be large, making it difficult to achieve the downsizing of the television receiving apparatus.

Also, in the case of designing a front end unit having a function of dividing a digital broadcast signal into two and outputting one of the divided signals through to the outside, one can consider a construction in which a splitter for dividing a received signal is disposed in the prior stage part of the front end unit. However, with such a construction, the front end unit will be large by the space for arranging the splitter, making it difficult to achieve the downsizing of the television receiving apparatus. Therefore, in a television receiving apparatus provided with a composite front end unit, there has been a problem that, in terms of the downsizing, a limitation is imposed in coping with the applied functions such as a function of outputting digital broadcast signals through to the outside.

### SUMMARY OF THE INVENTION

An object of the present invention is to provide a television receiving apparatus capable of conducting downsizing while increasing the degree of freedom in designing.

A television receiving apparatus according to one aspect of the present invention includes a first tuner unit receiving a broadcast signal and performing frequency conversion on the received broadcast signal into an IF signal or a base band signal for output; a first digital demodulating circuit demodulating the signal received from the first tuner unit and outputting a digital signal; a casing; a first input terminal; and a second digital demodulating circuit demodulating a signal received at the first input terminal and outputting a digital signal, wherein the first tuner unit, the first digital demodulating circuit, and the second digital demodulating circuit are housed in the casing, and the first input terminal is attached to the casing.

Preferably, the television receiving apparatus further includes a second tuner unit receiving a broadcast signal and performing frequency conversion on the received broadcast signal into an IF signal or a base band signal for output to the first input terminal, wherein the second tuner unit is placed outside the casing.

Preferably, the first tuner unit receives a terrestrial digital broadcast signal and performs frequency conversion on the received terrestrial digital broadcast signal into an IF signal for output; the first digital demodulating circuit performs OFDM demodulation and QAM demodulation on the IF signal received from the first tuner unit and outputs a digital signal; a base band signal generated by frequency conversion of a satellite digital broadcast signal is received at the first input terminal; and the second digital demodulating circuit performs PSK demodulation on the base band signal received at the first input terminal and outputs a digital signal.

Preferably, the first tuner unit receives a satellite digital broadcast signal and performs frequency conversion on the received satellite digital broadcast signal into a base band signal for output; the first digital demodulating circuit performs PSK demodulation on the base band signal received from the first tuner unit and outputs a digital signal; an IF signal generated by frequency conversion of a terrestrial digital broadcast signal is received at the first input terminal; and the second digital demodulating circuit performs OFDM demodulation and QAM demodulation on the IF signal received at the first input terminal and outputs a digital signal.

Preferably, the first tuner unit receives a terrestrial digital broadcast signal and performs frequency conversion on the received terrestrial digital broadcast signal into an IF signal for output; the television receiving apparatus further includes an analog tuner unit receiving a terrestrial analog broadcast signal and performing frequency conversion on the received terrestrial analog broadcast signal into an IF signal for output; and the analog tuner unit is housed in the casing.

More preferably, the television receiving apparatus further includes an analog demodulating circuit demodulating the IF signal received from the analog tuner unit and outputting a video signal and an audio signal; and the analog demodulating circuit is housed in the casing.

More preferably, the first tuner unit and the analog tuner unit are included in an integrated circuit.

Preferably, the first tuner unit receives a terrestrial digital broadcast signal and performs frequency conversion and OFDM demodulation on the received terrestrial digital broadcast signal to generate a base band signal; the first digital demodulating circuit performs QAM demodulation on the base band signal received from the first tuner unit and outputs a digital signal; a base band signal generated by frequency conversion of a satellite digital broadcast signal is received at the first input terminal; and the second digital demodulating circuit performs PSK demodulation on the base band signal received at the first input terminal and outputs a digital signal.

Preferably, the first tuner unit receives a terrestrial digital broadcast signal and performs frequency conversion on the received terrestrial digital broadcast signal into an IF signal for output; the first digital demodulating circuit performs OFDM demodulation and QAM demodulation on the IF signal received from the first tuner unit and outputs a digital signal; an IF signal generated by frequency conversion of a terrestrial digital broadcast signal is received at the first input terminal; and the second digital demodulating circuit performs OFDM demodulation and QAM demodulation on the IF signal received at the first input terminal and outputs a digital signal.

Preferably, the first tuner unit receives a satellite digital broadcast signal and performs frequency conversion on the received satellite digital broadcast signal into an base band signal for output; the first digital demodulating circuit performs PSK demodulation on the base band signal received from the first tuner unit and outputs a digital signal; a base band signal generated by frequency conversion of a satellite digital broadcast signal is received at the first input terminal; and the second digital demodulating circuit performs PSK demodulation on the base band signal received at the first input terminal and outputs a digital signal.

Preferably, the first tuner unit receives a terrestrial digital broadcast signal and performs frequency conversion on the received terrestrial digital broadcast signal into an IF signal for output; the first digital demodulating circuit performs OFDM demodulation and QAM demodulation on the IF signal received from the first tuner unit and outputs a digital signal; an IF signal generated by frequency conversion of a terrestrial digital broadcast signal is received at the first input terminal; the second digital demodulating circuit performs OFDM demodulation and QAM demodulation on the IF signal received at the first input terminal and outputs a digital signal; and the television receiving apparatus further includes a second input terminal at which a base band signal generated by frequency conversion of a satellite digital broadcast signal is received, a third input terminal at which a base band signal generated by frequency conversion of a satellite digital broadcast signal is received, a third digital demodulating circuit performing PSK demodulation on the base band signal received at the second input terminal and outputting a digital signal, and a fourth digital demodulating circuit performing PSK demodulation on the base band signal received at the third input terminal and outputting a digital signal.

Preferably, the first tuner unit receives a satellite digital broadcast signal and performs frequency conversion on the received satellite digital broadcast signal into an base band signal for output; the first digital demodulating circuit performs PSK demodulation on the base band signal received from the first tuner unit and outputs a digital signal; a base band signal generated by frequency conversion of a satellite digital broadcast signal is received at the first input terminal; and the second digital demodulating circuit performs PSK demodulation on the base band signal received at the first input terminal and outputs a digital signal; and the television receiving apparatus further includes a second input terminal at which an IF signal generated by frequency conversion of a terrestrial digital broadcast signal is received, a third input terminal at which an IF signal generated by frequency conversion of a terrestrial digital broadcast signal is received, a third digital demodulating circuit performing OFDM demodulation and QAM demodulation on the IF signal received at the second input terminal and outputting a digital signal, and a fourth digital demodulating circuit performing OFDM demodulation and QAM demodulation on the IF signal received at the third input terminal and outputting a digital signal.

Preferably, the first tuner unit is included in an integrated circuit.

Preferably, the television receiving apparatus further includes an RF input terminal that is attached to the casing and at which the broadcast signal is received, and an RF output terminal that is attached to the casing and from which the broadcast signal received at the RF input terminal is outputted.

Preferably, the television receiving apparatus further includes an MPEG decoder performing an MPEG decoding process on the digital signal received from the digital demodulating circuit.

According to the present invention, one can achieve size reduction while increasing the degree of freedom in designing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram showing a construction of a television receiving apparatus according to a first embodiment of the present invention;

FIG. 2 is an outlook view showing a state in which a composite front end unit provided with an RF output terminal for through-output of terrestrial digital broadcast signals and satellite digital broadcast signals is vertically placed on a substrate of a television receiving apparatus;

FIG. 3 is an outlook view of a television receiving apparatus according to the first embodiment of the present invention;

FIG. 4 is a functional block diagram showing a construction of a television receiving apparatus according to a second embodiment of the present invention;

FIG. 5 is a functional block diagram showing a construction of a television receiving apparatus according to a third embodiment of the present invention;

FIG. 6 is a functional block diagram showing a construction of a television receiving apparatus according to a fourth embodiment of the present invention;

FIG. 7 is a functional block diagram showing a construction of a television receiving apparatus according to a fifth embodiment of the present invention;

FIG. 8 is a functional block diagram showing a construction of a television receiving apparatus according to a sixth embodiment of the present invention;

FIG. 9 is a functional block diagram showing a construction of a television receiving apparatus according to a seventh embodiment of the present invention; and

FIG. 10 is a functional block diagram showing a construction of a television receiving apparatus according to an eighth embodiment of the present invention.

### DESCRIPTION OF THE PREFERRED EMBODIMENTS

Hereinafter, embodiments of the present invention will be described with reference to the attached drawings. Here, in the drawings, the same or equivalent parts are denoted by the same symbols, and the description thereof will not be repeated.

### First Embodiment

### [Construction and Basic Operation]

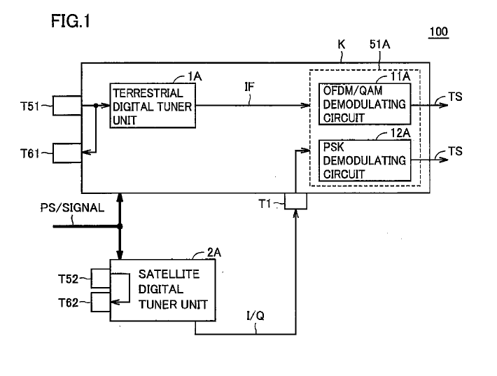

FIG. 1 is a functional block diagram showing a construction of a television receiving apparatus according to the first embodiment of the present invention.

With reference to FIG. 1, a television receiving apparatus 100 includes a casing K, an input terminal (first input terminal) T1, RF input terminals T51 and T52, RF output terminals T61 and T62, a terrestrial digital tuner unit (first tuner unit) 1A, a digital demodulating unit 51A which is, for example, a composite type digital demodulating IC, and a satellite digital tuner unit (second tuner unit) 2A. Digital demodulating unit 51A includes an OFDM/QAM demodulating circuit (first digital demodulating circuit) 11A and a PSK demodulating circuit (second digital demodulating circuit) 12A. Terrestrial digital tuner unit 1A and digital demodulating unit 51A are housed in casing K. Input terminal T1, RF input terminal T51, and RF output terminal T61 are attached to casing K. RF input terminal T52 and RF output terminal T62 are attached to a casing of satellite digital tuner unit 2A.

Terrestrial digital tuner unit 1A receives a terrestrial digital broadcast signal which is an RF (Radio Frequency) signal at RF input terminal T51, selects a signal of a frequency band corresponding to a channel to be selected from among the received terrestrial digital broadcast signals, and performs frequency conversion on the selected signal into an IF signal.

Here, terrestrial digital tuner unit 1A is, for example, what is known as a silicon tuner which is included in an integrated circuit. With such a construction, the size of terrestrial digital tuner unit 1A can be greatly reduced, thereby achieving downsizing and thickness reduction of the television receiving apparatus.

OFDM/QAM demodulating circuit 11A performs OFDM demodulation and QAM demodulation on the IF signal received from terrestrial digital tuner unit 1A to convert the IF signal into a TS signal.

A back end unit not illustrated in the drawings decodes the TS signal and outputs a video signal, an audio signal, and data.

Satellite digital tuner unit 2A receives a satellite digital broadcast signal which is an RF signal at RF input terminal T52, and selects a signal of a frequency band corresponding to a channel to be selected from among the received satellite digital broadcast signals. Also, an I/Q orthogonal detector included in satellite digital tuner unit 2A and not illustrated in the drawings performs direct conversion (frequency conversion) on the selected signal into two base band signals of an I signal and a Q signal having a phase difference of 90 degrees with respect to each other. The I signal and the Q signal that have been outputted from satellite digital tuner unit 2A are outputted to input terminal T1.

PSK demodulating circuit 12A performs QPSK (Phase Shift Keying) demodulation or 8PSK demodulation on the I signal and the Q signal received from satellite digital tuner unit 2A at input terminal T1 to convert the signal into a TS signal.

The terrestrial digital broadcast signal received at RF input terminal T51 is branched and one of branched signals is outputted from RF output terminal T61. The satellite digital broadcast signal received at RF input terminal T52 is branched and one of branched signals is outputted from RF output terminal T62.

Electric power is supplied from an apparatus not illustrated in the drawings to terrestrial digital tuner unit 1A, digital demodulating unit 51A, and satellite digital tuner unit 2A, and a control signal and the like is inputted and outputted via a bus.

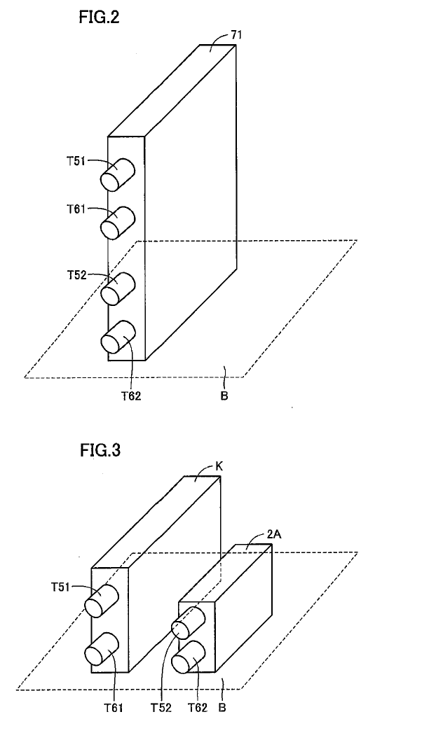

FIG. 2 is an outlook view showing a state in which a composite front end unit provided with an RF output terminal for through-output of terrestrial digital broadcast signals and satellite digital broadcast signals is vertically placed on a substrate of a television receiving apparatus.

With reference to FIG. 2, an RF input terminal T51 that receives a terrestrial digital broadcast signal, an RF input terminal T52 that receives a satellite digital broadcast signal, an RF output terminal T61 that outputs a terrestrial digital broadcast signal, and an RF output terminal T62 that outputs a satellite digital broadcast signal are attached to a composite front end unit 71.

In a television receiving apparatus provided with a composite front end unit carrying out the function of outputting a terrestrial digital broadcast signal and a satellite digital broadcast signal through to the outside, the sum of four terminals made of RF input terminals and RF output terminals for digital broadcast signals attached to composite front end unit 71 will be needed. Therefore, when composite front end unit 71 is placed vertically on a substrate B of the television receiving apparatus, the size of the television receiving apparatus in the vertical direction will be large. When composite front end unit 71 is placed horizontally on substrate B of the television receiving apparatus, the occupied area relative to substrate B in the television receiving apparatus will be large. Therefore, in a television receiving apparatus provided with a composite front end unit, there has been a problem that, in view of the downsizing, a limitation is imposed in coping with the applied functions such as a function of outputting digital broadcast signals through to the outside.

FIG. 3 is an outlook view of a television receiving apparatus according to the first embodiment of the present invention.

With reference to FIG. 3, RF input terminal T51 that receives a terrestrial digital broadcast signal and RF output terminal T61 that outputs a terrestrial digital broadcast signal are attached to casing K in which terrestrial digital tuner unit 1A is housed. RF input terminal T52 that receives a satellite digital broadcast signal and RF output terminal T62 that outputs a satellite digital broadcast signal are attached to the casing of satellite digital tuner unit 2A.

In the meantime, in a television receiving apparatus provided with a composite front end unit, there has been a problem that, in view of the downsizing, a limitation is imposed in coping with the applied functions such as a function of outputting digital broadcast signals through to the outside. However, in the television receiving apparatus according to the first embodiment of the present invention, terrestrial digital tuner unit 1A and digital demodulating unit 51A are housed in casing K. Satellite digital tuner unit 2A is placed on the outside of casing K. With such a construction, the influence of adding the RF output terminals for through-output of the digital broadcast signals to the digital tuner unit on the size of the whole television receiving apparatus can be reduced. Therefore, in the television receiving apparatus according to the first embodiment of the present invention, the influence caused by coping with the applied functions on the size of the whole television receiving apparatus can be reduced.

Also, in a television receiving apparatus equipped with a composite front end unit, there has been a problem that it is difficult to downsize the whole television receiving apparatus although the downsizing of the digital demodulating unit has been achieved. However, in the television receiving apparatus according to the first embodiment of the present invention, terrestrial digital tuner unit 1A and satellite digital tuner unit 2A are housed in different casings. With such a construction, the influence of the size of terrestrial digital tuner unit 1A and the influence of the size of satellite digital tuner unit 2A on the size of the front end unit are reduced, whereupon the effect of downsizing the whole television receiving apparatus by the downsizing of the digital demodulating unit is prevented from being disturbed by the size of the digital tuner units.

Therefore, with the television receiving apparatus according to the first embodiment of the present invention, one can achieve downsizing while increasing the degree of freedom in designing.

Here, the television receiving apparatus according to the first embodiment of the present invention is assumed to have a construction including satellite digital tuner unit 2A placed on the outside of casing K; however, it is not limited thereto. Television receiving apparatus 100 may have a construction such that satellite digital tuner unit 2A is not provided, and input terminal 1 receives a signal that is outputted from satellite digital tuner unit 2A located on the outside of television receiving apparatus 100. With such a construction, the range for selecting a tuner for satellite broadcast can be widened, and the degree of freedom in designing the front end unit can be increased.

Next, another embodiment of the present invention will be described with reference to the attached drawings. Here, in the drawings, the same or equivalent parts are denoted by the same symbols, and the description thereof will not be repeated.

### Second Embodiment

The present embodiment relates to a television receiving apparatus with reversed correspondence relationship of the broadcast signals with respect to the television receiving apparatus according to the first embodiment.

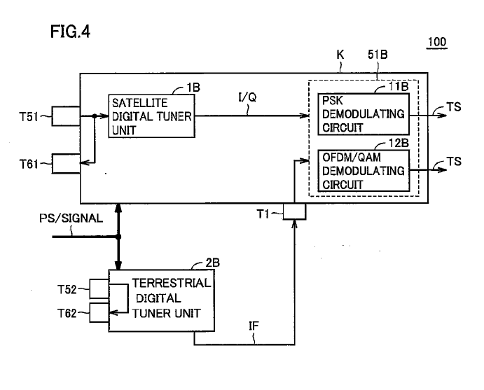

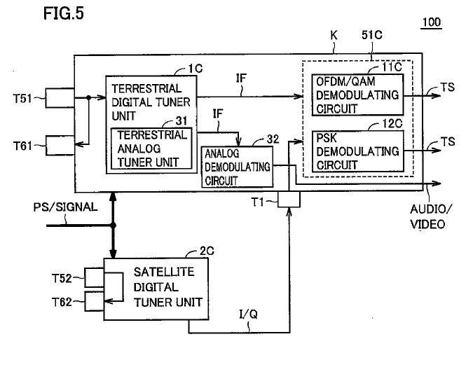

FIG. 4 is a functional block diagram showing a construction of a television receiving apparatus according to the second embodiment of the present invention.

With reference to FIG. 4, a television receiving apparatus 100 includes a casing K, an input terminal (first input terminal) T1, RF input terminals T51 and T52, RF output terminals T61 and T62, a satellite digital tuner unit (first tuner unit) 1B, a digital demodulating unit 51B which is, for example, a composite type digital demodulating IC, and a terrestrial digital tuner unit 2B. Digital demodulating unit 51B includes a PSK demodulating circuit (first digital demodulating circuit) 11B and an OFDM/QAM demodulating circuit (second digital demodulating circuit) 12B. Satellite digital tuner unit 1B and digital demodulating unit 51B are housed in casing K. Input terminal T1, RF input terminal T51, and RF output terminal T61 are attached to casing K. RF input terminal T52 and RF output terminal T62 are attached to a casing of terrestrial digital tuner unit 2B.

Satellite digital tuner unit 1B receives a satellite digital broadcast signal which is an RF signal at RF input terminal T51, and selects a signal of a frequency band corresponding to a channel to be selected from among the received satellite digital broadcast signals. Also, an I/Q orthogonal detector included in satellite digital tuner unit 1B and not illustrated in the drawings performs direct conversion (frequency conversion) on the selected signal into two base band signals of an I signal and a Q signal having a phase difference of 90 degrees with respect to each other.

PSK demodulating circuit 12B performs QPSK (Phase Shift Keying) demodulation or 8PSK demodulation on the I signal and the Q signal received from satellite digital tuner unit 1B to convert the signal into a TS signal.

Terrestrial digital tuner unit 2B receives a terrestrial digital broadcast signal which is an RF (Radio Frequency) signal at RF input terminal T52, selects a signal of a frequency band corresponding to a channel to be selected from among the received terrestrial digital broadcast signals, and performs frequency conversion on the selected signal into an IF signal. The IF signal that has been outputted from terrestrial digital tuner unit 2B is outputted to input terminal T1.

OFDM/QAM demodulating circuit 12 performs OFDM demodulation and QAM demodulation on the IF signal received from terrestrial digital tuner unit 2B at input terminal T1 to convert the IF signal into a TS signal.

The satellite digital broadcast signal received at RF input terminal T51 is branched and one of branched signals is outputted from RF output terminal T61. The terrestrial digital broadcast signal received at RF input terminal T52 is branched and one of branched signals is outputted from RF output terminal T62.

Here, currently, as compared with the terrestrial digital tuner unit, the satellite digital tuner unit is more advanced in terms of downsizing. Therefore, in the television receiving apparatus according to the second embodiment of the present invention, further downsizing of a television receiving apparatus can be achieved as compared with the television receiving apparatus according to the first embodiment of the present invention.

The construction of other constituent elements and the operation are similar to those of the television receiving apparatus according to the first embodiment of the present invention. Therefore, with a television receiving apparatus according to the second embodiment of the present invention, one can achieve downsizing while increasing the degree of freedom in designing.

Next, another embodiment of the present invention will be described with reference to the attached drawings. Here, in the drawings, the same or equivalent parts are denoted by the same symbols, and the description thereof will not be repeated.

### Third Embodiment

The present embodiment relates to a television receiving apparatus in which a function of receiving an analog broadcast signal is added to the television receiving apparatus according to the first embodiment.

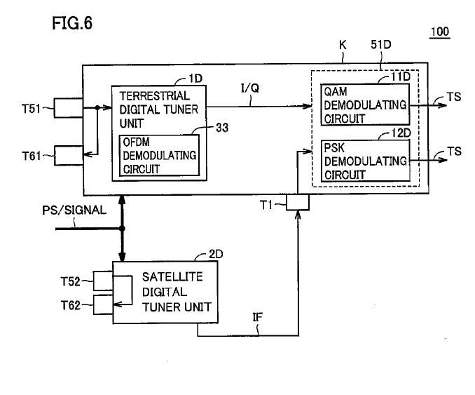

FIG. 5 is a functional block diagram showing a construction of a television receiving apparatus according to the third embodiment of the present invention.

With reference to FIG. 5, a television receiving apparatus 100 includes a casing K, an input terminal (first input terminal) T1, RF input terminals T51 and T52, RF output terminals T61 and T62, a terrestrial digital tuner unit (first tuner unit) 1C, an analog demodulating circuit 32, a digital demodulating unit 51C which is, for example, a composite type digital demodulating IC, and a satellite digital tuner unit 2C. Digital demodulating unit 51C includes an OFDM/QAM demodulating circuit (first digital demodulating circuit) 11C and a PSK demodulating circuit (second digital demodulating circuit) 12C. Terrestrial digital tuner unit 1C, analog demodulating circuit 32 and digital demodulating unit 51C are housed in casing K. Input terminal T1, RF input terminal T51, and RF output terminal T61 are attached to casing K. RF input terminal T52 and RF output terminal T62 are attached to a casing of satellite digital tuner unit 2C. Terrestrial digital tuner unit 1C includes a terrestrial analog tuner unit 31.

Terrestrial analog tuner unit 31 receives a terrestrial analog broadcast signal which is an RF signal at RF input terminal T51, selects a signal of a frequency band corresponding to a channel to be selected from among the received terrestrial analog broadcast signals, and performs frequency conversion on the selected signal into an IF signal.

Here, terrestrial digital tuner unit 1C is, for example, what is known as a silicon tuner which is included in an integrated circuit. With such a construction, the size of terrestrial digital tuner unit 1C can be greatly reduced, thereby achieving downsizing and thickness reduction of the television receiving apparatus.

Analog demodulating circuit 32 demodulates the IF signal received from terrestrial analog tuner unit 31, and outputs a video signal and an audio signal.

With such a construction, a front end unit can be constructed without separately mounting a tuner unit and an analog demodulating circuit for receiving an analog broadcast, thereby saving space for the front end unit and achieving downsizing of the television receiving apparatus.

Also, by using a television receiving apparatus according to the third embodiment of the present invention, television broadcasts can be received outside the terrestrial digital broadcasting area.

Also, by incorporating the analog demodulating circuit in the front end unit, further space saving of the television receiving apparatus can be achieved.

Here, the television receiving apparatus according to the third embodiment of the present invention has a construction provided with analog demodulating circuit 32; however, it is not limited thereto. Even with a construction such that the analog demodulating circuit is disposed outside the television receiving apparatus and the output of terrestrial digital tuner unit 1C is branched for outputting to the outside of the television receiving apparatus, the television broadcasts can be received in an area where the terrestrial digital broadcasts cannot be viewed or listened to.

The construction of other constituent elements and the operation are similar to those of the television receiving apparatus according to the first embodiment of the present invention. Therefore, with a television receiving apparatus according to the third embodiment of the present invention, one can achieve downsizing while increasing the degree of freedom in designing.

Next, another embodiment of the present invention will be described with reference to the attached drawings. Here, in the drawings, the same or equivalent parts are denoted by the same symbols, and the description thereof will not be repeated.

### Fourth Embodiment

The present embodiment relates to a television receiving apparatus in which a change has been made in the construction so that direct conversion is performed in the terrestrial digital tuner unit with respect to the television receiving apparatus according to the first embodiment.

FIG. 6 is a functional block diagram showing a construction of a television receiving apparatus according to the fourth embodiment of the present invention.

With reference to FIG. 6, a television receiving apparatus 100 includes a casing K, an input terminal (first input terminal) T1, RF input terminals T51 and T52, RF output terminals T61 and T62, a terrestrial digital tuner unit (first tuner unit) 1D, a digital demodulating unit 51D which is, for example, a composite type digital demodulating IC, and a satellite digital tuner unit 2D. Digital demodulating unit 51D includes a QAM demodulating circuit (first digital demodulating circuit) 11D and a PSK demodulating circuit (second digital demodulating circuit) 12D. Terrestrial digital tuner unit 1D includes an OFDM demodulating circuit 33. Terrestrial digital tuner unit 1D and digital demodulating unit 51D are housed in casing K. Input terminal T1, RF input terminal T51, and RF output terminal T61 are attached to casing K. RF input terminal T52 and RF output terminal T62 are attached to a casing of satellite digital tuner unit 2D.

Terrestrial digital tuner unit 1D receives a terrestrial digital broadcast signal which is an RF (Radio Frequency) signal at RF input terminal T51, selects a signal of a frequency band corresponding to a channel to be selected from among the received terrestrial digital broadcast signals, and performs frequency conversion on the selected signal into an IF signal. OFDM demodulating circuit 33 included in terrestrial digital tuner unit 1D performs OFDM demodulation on the IF signal to generate two base band signals of an I signal and a Q signal having a phase difference of 90 degrees with respect to each other.

QAM demodulating circuit 11D performs QAM demodulation on the I signal and the Q signal received from terrestrial digital tuner unit 1D to convert the signal into a TS signal.

The construction of other constituent elements and the operation are similar to those of the television receiving apparatus according to the first embodiment of the present invention. Therefore, with a television receiving apparatus according to the fourth embodiment of the present invention, one can achieve downsizing while increasing the degree of freedom in designing.

Next, another embodiment of the present invention will be described with reference to the attached drawings. Here, in the drawings, the same or equivalent parts are denoted by the same symbols, and the description thereof will not be repeated.

### Fifth Embodiment

The present embodiment relates to a television receiving apparatus in which both of the two systems perform processing on the terrestrial digital broadcast signals.

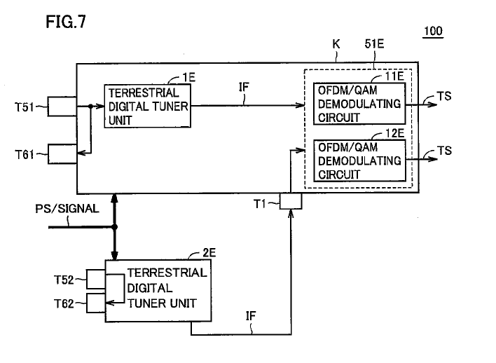

FIG. 7 is a functional block diagram showing a construction of a television receiving apparatus according to the fifth embodiment of the present invention.

With reference to FIG. 7, a television receiving apparatus 100 includes a casing K, an input terminal (first input terminal) T1, RF input terminals T51 and T52, RF output terminals T61 and T62, a terrestrial digital tuner unit (first tuner unit) 1E, a digital demodulating unit 51E which is, for example, a composite type digital demodulating IC, and a terrestrial digital tuner unit 2E. Digital demodulating unit 51E includes an OFDM/QAM demodulating circuit (first digital demodulating circuit) 11E and an OFDM/QAM demodulating circuit (second digital demodulating circuit) 12E. Terrestrial digital tuner unit 1E and digital demodulating unit 51E are housed in casing K. Input terminal T1, RF input terminal T51, and RF output terminal T61 are attached to casing K. RF input terminal T52 and RF output terminal T62 are attached to a casing of terrestrial digital tuner unit 2E.

Terrestrial digital tuner unit 2E receives a terrestrial digital broadcast signal which is an RF (Radio Frequency) signal at RF input terminal T52, selects a signal of a frequency band corresponding to a channel to be selected from among the received terrestrial digital broadcast signals, and performs frequency conversion on the selected signal into an IF signal. The IF signal that has been outputted from terrestrial digital tuner unit 2E is outputted to input terminal T1.

OFDM/QAM demodulating circuit 12E performs QPSK (Phase Shift Keying) demodulation or 8PSK demodulation on the I signal and the Q signal received from terrestrial digital tuner unit 2E at input terminal T1 to convert the signal into a TS signal.

Therefore, the television receiving apparatus according to the fifth embodiment of the present invention can comply with the applied functions such as a two-screen display function, a counter-program recording function, and a diversity receiving function used in mobile communication or the like.

The construction of other constituent elements and the operation are similar to those of the television receiving apparatus according to the first embodiment of the present invention. Therefore, with a television receiving apparatus according to the fifth embodiment of the present invention, one can achieve downsizing while increasing the degree of freedom in designing.

Next, another embodiment of the present invention will be described with reference to the attached drawings. Here, in the drawings, the same or equivalent parts are denoted by the same symbols, and the description thereof will not be repeated.

### Sixth Embodiment

The present embodiment relates to a television receiving apparatus in which both of the two systems perform processing on the satellite digital broadcast signals.

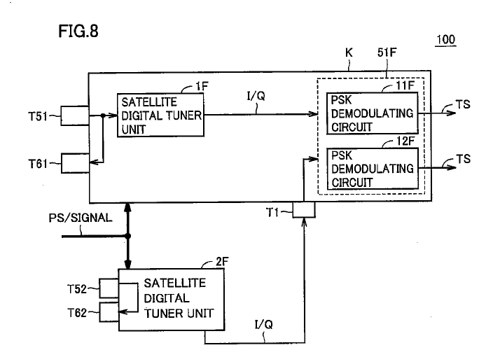

FIG. 8 is a functional block diagram showing a construction of a television receiving apparatus according to the sixth embodiment of the present invention.

With reference to FIG. 8, a television receiving apparatus 100 includes a casing K, an input terminal (first input terminal) T1, RF input terminals T51 and T52, RF output terminals T61 and T62, a satellite digital tuner unit (first tuner unit) 1F, a digital demodulating unit 51F which is, for example, a composite type digital demodulating IC, and a satellite digital tuner unit 2F. Digital demodulating unit 51F includes a PSK demodulating circuit (first digital demodulating circuit) 11F and a PSK demodulating circuit (second digital demodulating circuit) 12F. Satellite digital tuner unit 1F and digital demodulating unit 51F are housed in casing K. Input terminal T1, RF input terminal T51, and RF output terminal T61 are attached to casing K. RF input terminal T52 and RF output terminal T62 are attached to a casing of satellite digital tuner unit 2F.

Satellite digital tuner unit 1F receives a satellite digital broadcast signal which is an RF signal at RF input terminal T51, and selects a signal of a frequency band corresponding to a channel to be selected from among the received satellite digital broadcast signals. Also, an I/Q orthogonal detector included in satellite digital tuner unit 1F and not illustrated in the drawings performs direct conversion (frequency conversion) on the selected signal into two base band signals of an I signal and a Q signal having a phase difference of 90 degrees with respect to each other.

PSK demodulating circuit 11F performs QPSK (Phase Shift Keying) demodulation or 8PSK demodulation on the I signal and the Q signal received from satellite digital tuner unit 1F to convert the signal into a TS signal.

Therefore, the television receiving apparatus according to the sixth embodiment of the present invention can comply with the applied functions such as a two-screen display function, a counter-program recording function, and a diversity receiving function used in mobile communication or the like.

The construction of other constituent elements and the operation are similar to those of the television receiving apparatus according to the first embodiment of the present invention. Therefore, with a television receiving apparatus according to the sixth embodiment of the present invention, one can achieve downsizing while increasing the degree of freedom in designing.

Next, another embodiment of the present invention will be described with reference to the attached drawings. Here, in the drawings, the same or equivalent parts are denoted by the same symbols, and the description thereof will not be repeated.

### Seventh Embodiment

The present embodiment relates to a television receiving apparatus in which two systems that perform processing on the digital broadcast signals are added with respect to the television receiving apparatus according to the first embodiment of the present invention.

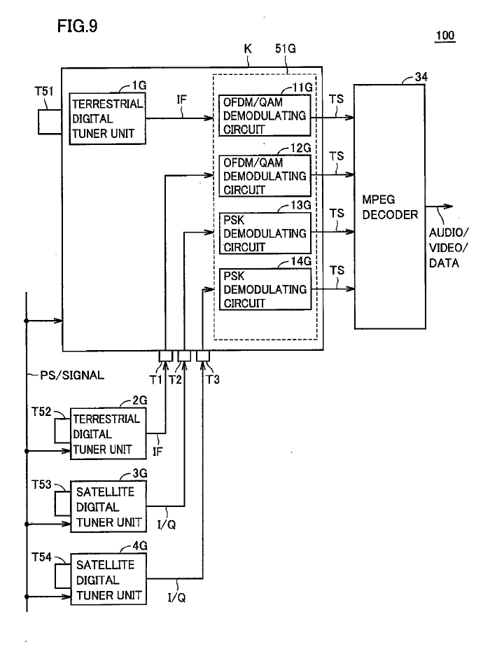

FIG. 9 is a functional block diagram showing a construction of a television receiving apparatus according to the seventh embodiment of the present invention.

With reference to FIG. 9, a television receiving apparatus 100 includes a casing K, input terminals (first to third input terminals) T1 to T3, RF input terminals T51 to T54, a terrestrial digital tuner unit (first tuner unit) 1G, a digital demodulating unit 51G which is, for example, a composite type digital demodulating IC, a terrestrial digital tuner unit 2G, satellite digital tuner units 3G and 4G, and an MPEG decoder 34 which is a back end unit. Digital demodulating unit 51G includes OFDM/QAM demodulating circuits (first and second digital demodulating circuits) 11G and 12G, and PSK demodulating circuits (third and fourth digital demodulating circuits) 13G and 14G. Terrestrial digital tuner unit 1G and digital demodulating unit 51G are housed in casing K. Input terminals T1 to T3 and RF input terminal T51 are attached to casing K. RF input terminals T52 to T54 are attached respectively to casings of terrestrial digital tuner unit 2G and satellite digital tuner units 3G and 4G.

Terrestrial digital tuner unit 2G receives a terrestrial digital broadcast signal which is an RF (Radio Frequency) signal at RF input terminal T52, selects a signal of a frequency band corresponding to a channel to be selected from among the received terrestrial digital broadcast signals, and performs frequency conversion on the selected signal into an IF signal. The IF signal that has been outputted from terrestrial digital tuner unit 2G is outputted to input terminal T1.

OFDM/QAM demodulating circuit 12G performs OFDM demodulation and QAM demodulation on the IF signal received from terrestrial digital tuner unit 2G at input terminal T1 to convert the IF signal into a TS signal.

Satellite digital tuner units 3G and 4G receive satellite digital broadcast signals which are RF signals respectively at RF input terminals T53 and T54, and select signals of a frequency band corresponding to a channel to be selected from among the received satellite digital broadcast signals. Also, I/Q orthogonal detectors included in satellite digital tuner units 3G and 4G and not illustrated in the drawings perform direct conversion (frequency conversion) on the selected signal into two base band signals of an I signal and a Q signal having a phase difference of 90 degrees with respect to each other. The two sets of the I signal and the Q signal that have been outputted from satellite digital tuner units 3G and 4G are outputted respectively to input terminals T2 and T3.

PSK demodulating circuits 13G and 14G perform QPSK (Phase Shift Keying) demodulation or 8PSK demodulation on the two sets of the I signal and the Q signal received from satellite digital tuner units 3G and 4G at input terminals T2 and T3 to convert the signals into TS signals.

MPEG decoder 34 performs an MPEG decoding process on the TS signals received from OFDM/QAM demodulating circuits 11G and 12G and from PSK demodulating circuits 13G and 14G, and outputs video signals, audio signals, and data. With such a construction, the front end unit and the back end unit can be integrated, thereby achieving reduction of the development period and development cost of the television receiving apparatus.

Electric power is supplied from an apparatus not illustrated in the drawings to terrestrial digital tuner units 1G and 2G, digital demodulating unit 51G, and satellite digital tuner units 3G and 4G, and a control signal and the like is inputted and outputted via a bus.

Therefore, the television receiving apparatus according to the seventh embodiment of the present invention can comply with the applied functions such as a two-screen display function, a counter-program recording function, and a diversity receiving function used in mobile communication or the like with respect to each of terrestrial digital broadcasting and satellite digital broadcasting.

Next, another embodiment of the present invention will be described with reference to the attached drawings. Here, in the drawings, the same or equivalent parts are denoted by the same symbols, and the description thereof will not be repeated.

### Eighth Embodiment

The present embodiment relates to a television receiving apparatus in which two systems that perform processing on the digital broadcast signals are added with respect to the television receiving apparatus according to the first embodiment of the present invention.

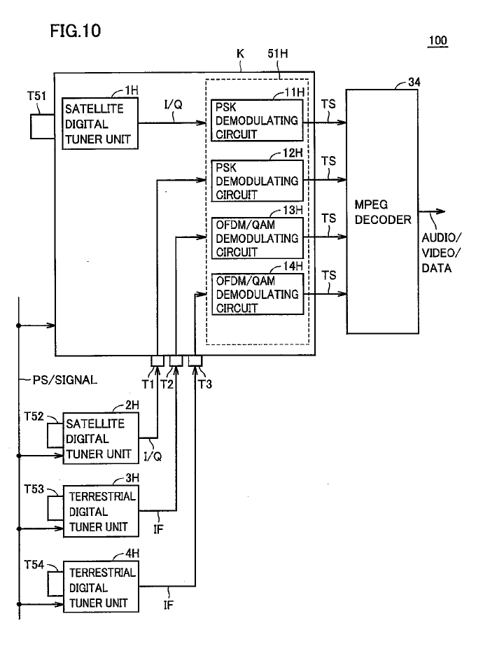

FIG. 10 is a functional block diagram showing a construction of a television receiving apparatus according to the eighth embodiment of the present invention.

With reference to FIG. 10, a television receiving apparatus 100 includes a casing K, input terminals (first to third input terminals) T1 to T3, RF input terminals T51 to T54, a satellite digital tuner unit (first tuner unit) 1H, a digital demodulating unit 51H which is, for example, a composite type digital demodulating IC, a satellite digital tuner unit 2H, terrestrial digital tuner units 3H and 4H, and an MPEG decoder 34 which is a back end unit. Digital demodulating unit 51H includes PSK demodulating circuits (first and second digital demodulating circuits) 11H and 12H, and OFDM/QAM demodulating circuits (third and fourth digital demodulating circuits) 13H and 14H. Satellite digital tuner unit 1H and digital demodulating unit 51H are housed in casing K. Input terminals T1 to T3 and RF input terminal T51 are attached to casing K. RF input terminals T52 to T54 are attached respectively to casings of satellite digital tuner unit 2H and terrestrial digital tuner units 3H and 4H.

Satellite digital tuner unit 1H receives a satellite digital broadcast signal which is an RF signal at RF input terminal T51, and selects a signal of a frequency band corresponding to a channel to be selected from among the received satellite digital broadcast signals. Also, an I/Q orthogonal detector included in satellite digital tuner unit 1H and not illustrated in the drawings performs direct conversion (frequency conversion) on the selected signal into two base band signals of an I signal and a Q signal having a phase difference of 90 degrees with respect to each other.

PSK demodulating circuit 11H performs QPSK (Phase Shift Keying) demodulation or 8PSK demodulation on the I signal and the Q signal received from satellite digital tuner unit 1H to convert the signal into a TS signal.

Satellite digital tuner unit 2H receives a satellite digital broadcast signal which is an RF signal at RF input terminal T52, and selects a signal of a frequency band corresponding to a channel to be selected from among the received satellite digital broadcast signals. Also, an I/Q orthogonal detector included in satellite digital tuner unit 2H and not illustrated in the drawings performs direct conversion (frequency conversion) on the selected signal into two base band signals of an I signal and a Q signal having a phase difference of 90 degrees with respect to each other. The I signal and the Q signal that have been outputted from satellite digital tuner unit 2H are outputted to input terminal T1.

PSK demodulating circuit 12H performs QPSK (Phase Shift Keying) demodulation or 8PSK demodulation on the I signal and the Q signal received from satellite digital tuner unit 2H at input terminal T1 to convert the signal into a TS signal.

Terrestrial digital tuner units 3H and 4H receive terrestrial digital broadcast signals which are RF (Radio Frequency) signals respectively at RF input terminals T53 and T54, select signals of a frequency band corresponding to a channel to be selected from among the received terrestrial digital broadcast signals, and perform frequency conversion on the selected signals into IF signals. The IF signals that have been outputted from terrestrial digital tuner units 3H and 4H are outputted respectively to input terminals T2 and T3.

OFDM/QAM demodulating circuits 13H and 14H perform OFDM demodulation and QAM demodulation on the IF signals received from terrestrial digital tuner units 3H and 4H at input terminals T2 and T3 to convert the IF signal into a TS signal.

MPEG decoder 34 performs an MPEG decoding process on the TS signals received from PSK demodulating circuits 11H and 12H and from OFDM/QAM demodulating circuits 13H and 14H, and outputs video signals, audio signals, and data. With such a construction, the front end unit and the back end unit can be integrated, thereby achieving reduction of the development period and development cost of the television receiving apparatus.

Therefore, the television receiving apparatus according to the eighth embodiment of the present invention can comply with the applied functions such as a two-screen display function, a counter-program recording function, and a diversity receiving function used in mobile communication or the like with respect to each of terrestrial digital broadcasting and satellite digital broadcasting.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A television receiving apparatus comprising:
a first tuner unit receiving a broadcast signal and performing frequency conversion on said received broadcast signal into an IF signal or a base band signal for output;
a first digital demodulating circuit demodulating the signal received from said first tuner unit and outputting a digital signal;
a casing;
a first input terminal; and
a second digital demodulating circuit demodulating a signal received at said first input terminal and outputting a digital signal, wherein
said first tuner unit, said first digital demodulating circuit, and said second digital demodulating circuit are housed in said casing, and
said first input terminal is attached to said casing.

2. The television receiving apparatus according to claim 1, further comprising a second tuner unit receiving a broadcast signal and performing frequency conversion on the received broadcast signal into an IF signal or a base band signal for output to said first input terminal, wherein
said second tuner unit is placed outside said casing.

3. The television receiving apparatus according to claim 1, wherein
said first tuner unit receives a terrestrial digital broadcast signal and performs frequency conversion on said received terrestrial digital broadcast signal into an IF signal for output,
said first digital demodulating circuit performs OFDM demodulation and QAM demodulation on the IF signal received from said first tuner unit and outputs a digital signal,
a base band signal generated by frequency conversion of a satellite digital broadcast signal is received at said first input terminal, and
said second digital demodulating circuit performs PSK demodulation on the base band signal received at said first input terminal and outputs a digital signal.

4. The television receiving apparatus according to claim 1, wherein
said first tuner unit receives a satellite digital broadcast signal and performs frequency conversion on said received satellite digital broadcast signal into a base band signal for output,
said first digital demodulating circuit performs PSK demodulation on the base band signal received from said first tuner unit and outputs a digital signal,
an IF signal generated by frequency conversion of a terrestrial digital broadcast signal is received at said first input terminal, and
said second digital demodulating circuit performs OFDM demodulation and QAM demodulation on the IF signal received at said first input terminal and outputs a digital signal.

5. The television receiving apparatus according to claim 1, wherein
said first tuner unit receives a terrestrial digital broadcast signal and performs frequency conversion on said received terrestrial digital broadcast signal into an IF signal for output,
said television receiving apparatus further comprises an analog tuner unit receiving a terrestrial analog broadcast signal and performing frequency conversion on said received terrestrial analog broadcast signal into an IF signal for output, and
said analog tuner unit is housed in said casing.

6. The television receiving apparatus according to claim 5, wherein
said television receiving apparatus further comprises an analog demodulating circuit demodulating the IF signal received from said analog tuner unit and outputting a video signal and an audio signal, and
said analog demodulating circuit is housed in said casing.

7. The television receiving apparatus according to claim 5, wherein said first tuner unit and said analog tuner unit are included in an integrated circuit.

8. The television receiving apparatus according to claim 1, wherein
said first tuner unit receives a terrestrial digital broadcast signal and performs frequency conversion and OFDM demodulation on said received terrestrial digital broadcast signal to generate a base band signal,
said first digital demodulating circuit performs QAM demodulation on the base band signal received from said first tuner unit and outputs a digital signal,
a base band signal generated by frequency conversion of a satellite digital broadcast signal is received at said first input terminal, and
said second digital demodulating circuit performs PSK demodulation on the base band signal received at said first input terminal and outputs a digital signal.

9. The television receiving apparatus according to claim 1, wherein
said first tuner unit receives a terrestrial digital broadcast signal and performs frequency conversion on said received terrestrial digital broadcast signal into an IF signal for output,
said first digital demodulating circuit performs OFDM demodulation and QAM demodulation on the IF signal received from said first tuner unit and outputs a digital signal,
an IF signal generated by frequency conversion of a terrestrial digital broadcast signal is received at said first input terminal, and
said second digital demodulating circuit performs OFDM demodulation and QAM demodulation on the IF signal received at said first input terminal and outputs a digital signal.

10. The television receiving apparatus according to claim 1, wherein
said first tuner unit receives a satellite digital broadcast signal and performs frequency conversion on said received satellite digital broadcast signal into an base band signal for output,
said first digital demodulating circuit performs PSK demodulation on the base band signal received from said first tuner unit and outputs a digital signal,
a base band signal generated by frequency conversion of a satellite digital broadcast signal is received at said first input terminal, and
said second digital demodulating circuit performs PSK demodulation on the base band signal received at said first input terminal and outputs a digital signal.

11. The television receiving apparatus according to claim 1, wherein
said first tuner unit receives a terrestrial digital broadcast signal and performs frequency conversion on said received terrestrial digital broadcast signal into an IF signal for output,
said first digital demodulating circuit performs OFDM demodulation and QAM demodulation on the IF signal received from said first tuner unit and outputs a digital signal,
an IF signal generated by frequency conversion of a terrestrial digital broadcast signal is received at said first input terminal,
said second digital demodulating circuit performs OFDM demodulation and QAM demodulation on the IF signal received at said first input terminal and outputs a digital signal, and
said television receiving apparatus further comprises:
a second input terminal at which a base band signal generated by frequency conversion of a satellite digital broadcast signal is received;
a third input terminal at which a base band signal generated by frequency conversion of a satellite digital broadcast signal is received;
a third digital demodulating circuit performing PSK demodulation on the base band signal received at said second input terminal and outputting a digital signal; and
a fourth digital demodulating circuit performing PSK demodulation on the base band signal received at said third input terminal and outputting a digital signal.

12. The television receiving apparatus according to claim 1, wherein
said first tuner unit receives a satellite digital broadcast signal and performs frequency conversion on said received satellite digital broadcast signal into an base band signal for output,
said first digital demodulating circuit performs PSK demodulation on the base band signal received from said first tuner unit and outputs a digital signal,
a base band signal generated by frequency conversion of a satellite digital broadcast signal is received at said first input terminal,
said second digital demodulating circuit performs PSK demodulation on the base band signal received at said first input terminal and outputs a digital signal, and
said television receiving apparatus further comprises:
a second input terminal at which an IF signal generated by frequency conversion of a terrestrial digital broadcast signal is received;
a third input terminal at which an IF signal generated by frequency conversion of a terrestrial digital broadcast signal is received;
a third digital demodulating circuit performing OFDM demodulation and QAM demodulation on the IF signal received at said second input terminal and outputting a digital signal; and
a fourth digital demodulating circuit performing OFDM demodulation and QAM demodulation on the IF signal received at said third input terminal and outputting a digital signal.

13. The television receiving apparatus according to claim 1, wherein said first tuner unit is included in an integrated circuit.

14. The television receiving apparatus according to claim 1, wherein said television receiving apparatus further comprises:
an RF input terminal that is attached to said casing and at which said broadcast signal is received; and
an RF output terminal that is attached to said casing and from which said broadcast signal received at said RF input terminal is outputted.

15. The television receiving apparatus according to claim 1, wherein said television receiving apparatus further comprises an MPEG decoder performing an MPEG decoding process on the digital signal received from said digital demodulating circuit.
